(19) United States
(12) Patent Application Publication
(10) Pub. No.: US 2005/0238314 A1
(43) Pub. Date: Oct. 27, 2005

(54) Recording system, recording apparatus, recording method, recording program and recording medium

(76) Inventors: Sako Asayama, Nara (JP); Hiroshi Kase, Osaka (JP); Keiko Tanaka, Osaka (JP); Yasuhiro Kubo, Osaka (JP); Kevin Leigh La Chapelle, Redmond, WA (US); Ian Cameron Mercer, Sammammish, WA (US); Brian James Walker, Duvall, WA (US)

Correspondence Address: RATNERPRESTIA, P O BOX 980, VALLEY FORGE, PA, 19482-0980, US

(21) Appl. No.: 11/089,964

(22) Filed: Mar. 25, 2005

Related U.S. Application Data
(60) Provisional application No. 60/557,634, filed on Mar. 30, 2004.

(51) Int. Cl. G06F 17/00

(52) U.S. Cl. 386/1

(57) ABSTRACT

A recording apparatus reads a content management file from a file information obtaining means, and a data analysis and search means searches for a specified digital content information storing portions from the read content management file and searches for a play list file including specified digital contents in reproduction order based on reference play list information of the content information storing portions. The file information obtaining means reads a relevant play list file, and the data analysis and search means searches for an updated location and notifies a play list file creation means thereof so that the play list file creation means correctly updates the play list file.

### RELATED APPLICATIONS

This application claims priority of U.S. Provisional Application Ser. No. 60/557,634, filed on Mar. 30, 2004.

### BACKGROUND OF THE INVENTION

1. Field of the Invention

The present invention relates to a recording apparatus of recording a digital content file on a recording medium and information on the digital content file recorded on the recording medium.

2. Related Art of the Invention

In recent years, on a recording medium storing a large amount of digital contents (music, static images and moving images), the contents are actually handled by using a management file such as a content management file which collectively manages property information on the contents and the like or a play list file which defines reproduction order of the contents, in order to reduce file search time and improve convenience for a user. Thus, a data file reproducing apparatus can obtain the information on digital contents from the management file without accessing each individual file to read the property information so as to improve processing speed in operation.

In the case of applying this content management method to a rewritable recording medium, however, it is necessary, on deleting certain contents from a recording medium, to simultaneously delete information on the contents and update a content management file and a play list file.

In general, there are a plurality of play list files having various kinds of reproduction order defined for each of the contents on the medium. Therefore, there are the cases where a plurality of them exist on a medium and a piece of content is referred to by a plurality of play list files. There are also the cases where a large number of play list files exist on a large-capacity recording medium having a large amount of digital contents recorded thereon. In such cases, there is a problem that, to identify the play list file requiring an update and delete relevant content information, a search must be made to determine whether or not the content information exists as to all the play list files on the recording medium, which takes processing time.

### SUMMARY OF THE INVENTION

The present invention is an invention for the sake of solving the problem. It is a recording apparatus capable of extracting the information on the digital contents and creating the content management file and play list file to write them to the recording medium together with the digital contents, and it holds content management file creation means of storing the information identifying the play list files by which digital contents are referred to in each content information storing portion of the content management file.

The content management file created by the recording apparatus of the present invention holds an area of storing the number of the play list files referring to the contents and an area of storing the information (file IDs for instance) identifying the play list files referring to the contents in the content information storing portion of storing the information on the content files. Furthermore, as to the area of storing the information identifying the play list files, predetermined free space is held.

When deleting certain contents on the recording medium, a data file rewriting apparatus can obtain the number of the play list files referring to the digital contents and the information identifying the play list files from the content information of the content management file, and identify the play list files referring to the digital contents from the obtained information so as to delete the information on the digital contents and update the play list files. Thus, it is possible to reduce update process time of the play list files in conjunction with the deletion of the digital contents and improve convenience for a user.

### BRIEF DESCRIPTION OF THE DRAWINGS

FIG. 1 is a functional block diagram of a recording apparatus and a recording medium created by the recording apparatus according to first, second, third, fourth and fifth embodiments.

FIG. 2 are data structure diagrams of a content management file and a play list file according to a first embodiment.

FIG. 3 are data structure diagrams of the content management file and the play list file according to a second embodiment.

FIG. 4 are data structure diagrams of the content management file and the play list file according to third and fourth embodiments.

FIG. 5 is a data structure diagram of a content information storing portion of the content management file according to a fifth embodiment.

FIG. 6 is a data structure diagram of the content management file according to the fifth embodiment.

FIG. 7 is a data structure diagram of the content management file according to the fifth embodiment.

FIG. 8 is a flowchart showing a flow of a process of the recording apparatus 100 according to the first embodiment.

FIG. 9 is a flowchart showing the flow of the process of the recording apparatus 100 according to the second embodiment.

FIG. 10 is a flowchart showing the flow of the process of the recording apparatus 100 according to the third embodiment.

FIG. 11 is a flowchart showing the flow of the process of the recording apparatus 100 according to the fourth embodiment.

FIG. 12 is a flowchart showing the flow of the process of the recording apparatus 100 according to the fifth embodiment.

### DESCRIPTION OF SYMBOLS

100 Recording apparatus
101 Information extraction means
102 Content management file creation means
103 Content reproduction order specification means
104 Play list file creation means
105 Recording means
106 File information obtaining means
107 Data analysis and search means
120 Recording medium
123 Digital contents
130 Content management file
131 Content information storing portion
132 Medium file ID storing portion
133 Reference play list number storing portion
134 Reference play list file information storing portion
135 File name storing portion
136 Free space of storing reference play list file information
137 Next medium file ID storing portion
138 Offset-to-data A storing portion
139 Next play list file ID storing portion
140 Play list file
141 Content reproduction order definition portion

### Preferred Embodiments of the Invention

Hereafter, a description will be given by using the drawings as to a recording apparatus and a recording medium according to an embodiment of the present invention.

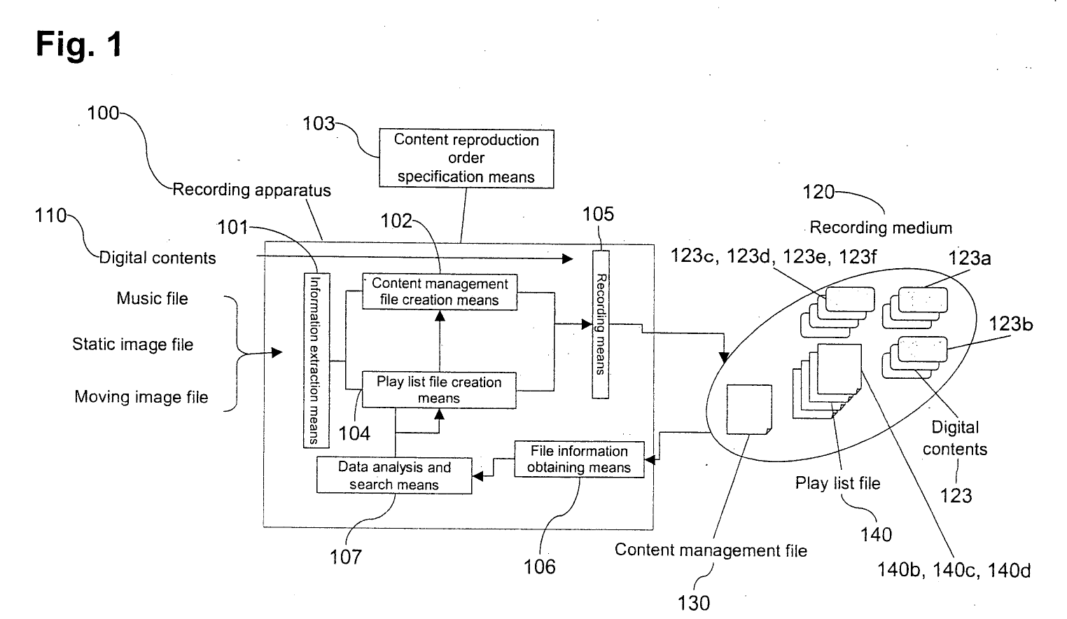

(FIG. 1: The Recording Apparatus and the Recording Medium Created by the Recording Apparatus)

FIG. 1 is a functional block diagram of a recording apparatus 100 according to first, second, third, fourth and fifth embodiments of the present invention.

The recording apparatus 100 comprises information extraction means 101 of extracting property information and the like on digital contents 110 to be recorded on the recording medium 120 such as a file name of relevant digital contents for instance, and besides, reproduction time length, an artist name, a genre name, a track number and so on in the case where the digital contents are a music file, the reproduction time length and so on in the case where the digital contents are a moving image file, and a vertical size, a horizontal size and so on of the file in the case where the digital contents are a static image file; content management file creation means 102 of creating a content management file 130 from the information extracted from the information extraction means 101; content reproduction order specification means 103 capable of specifying reproduction order of the contents; play list file creation means 104 of determining the reproduction order of the contents based on the contents specified by the content reproduction order specification means 103 and creating a play list file 140 based on the determined reproduction order; and recording means 105 of recording the digital contents 110, the content management file 130 and the play list file 140 on the recording medium 120 in a predetermined form. It also comprises file information obtaining means 106 of obtaining information on the content management file 130 and the play list file 140 from the recording medium 120 having the digital contents 110, the content management file 130 and the play list file 140 recorded thereon in the predetermined form; and data analysis and search means 107 of analyzing the information obtained from the file information obtaining means 106 to search data, create rewrite data and give a rewrite instruction.

The content reproduction order specification means 103 may be the means which has a input means such as a button or a keyboard and allows the user to select the digital contents 110 by operating a button or a keyboard and specify the reproduction order of the digital contents 110. And if the recording apparatus 100 has the means (not shown) capable of storing a rule of specifying the reproduction order of the digital contents 110 in advance, it may also be the means of storing alphabetic reproduction order of the file names for instance, or in the case of the music file, alphabetic reproduction order of the artists of the relevant music and creation rules of creating the play list file collecting only music files of the same artist so as to specify the creation of the play list file based on the stored contents.

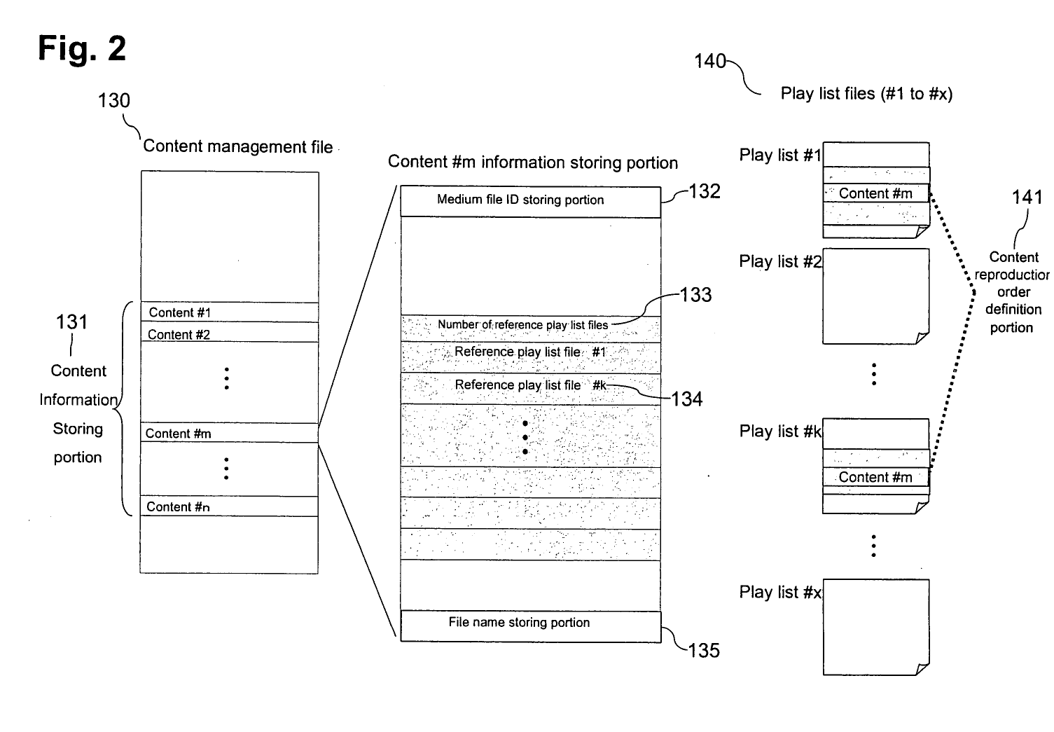

(FIG. 2: Data Structure Diagrams of the Content Management File and the Play List File)

FIG. 2 are data structure diagrams of the content management file 130 and the play list file 140 created by the recording apparatus 100 according to this first embodiment and recorded on the recording medium 120, and shows in particular a data storing portion created and updated (added or deleted) in this embodiment.

The content management file 130 has a content information storing portion 131 of storing the property information and the like on each of the relevant digital contents.

When recording the digital contents on the recording medium 120, the recording apparatus 100 provides a medium file ID (for instance, an integer starting from 1 and increasing by one) to the digital contents in order to uniquely identify each of the digital contents on the recording medium 120.

The recording apparatus 100 also provides a play list ID (for instance, an integer starting from 1 and increasing by one) to each play list file in order to uniquely identify one or a plurality of play list files created based on the reproduction order specified by the content reproduction order specification means 103 on the recording medium 120. Furthermore, it creates the file name of each play list file from a character string including the play list ID or the play list ID itself and records it on the recording medium 120.

The content information storing portion 131 has a medium file ID storing portion 132 of storing an ID for each of the digital contents; a reference play list file number storing portion 133 of storing the number of play list files referring to the relevant digital contents, that is, the play list files in which the relevant digital contents are defined as the reproduction order; a reference play list file information storing portion 134 of storing the information identifying the play list file referring to the relevant digital contents, that is, the play list ID of the play list file; and a file name storing portion 135 of storing the file name of the relevant digital contents.

The play list file 140 has a content reproduction order definition portion 141 of storing the medium file IDs of the digital contents in reproduction order based on the reproduction order of the contents specified by the content reproduction order specification means 103. A digital content 123 on the recording medium 120 is given a unique medium file ID on the recording medium 120 by the content management file 130. Therefore, in the case of defining the reproduction order of the digital contents in the play list file 140, the data to be stored in the content reproduction order definition portion 141 may be only the medium file ID without using the file name, a directory name and so on so as to reduce file size of the play list file.

A plurality of play list files may exist on the recording medium 120, and one digital content may be referred to by a plurality of play list files.

### First Embodiment

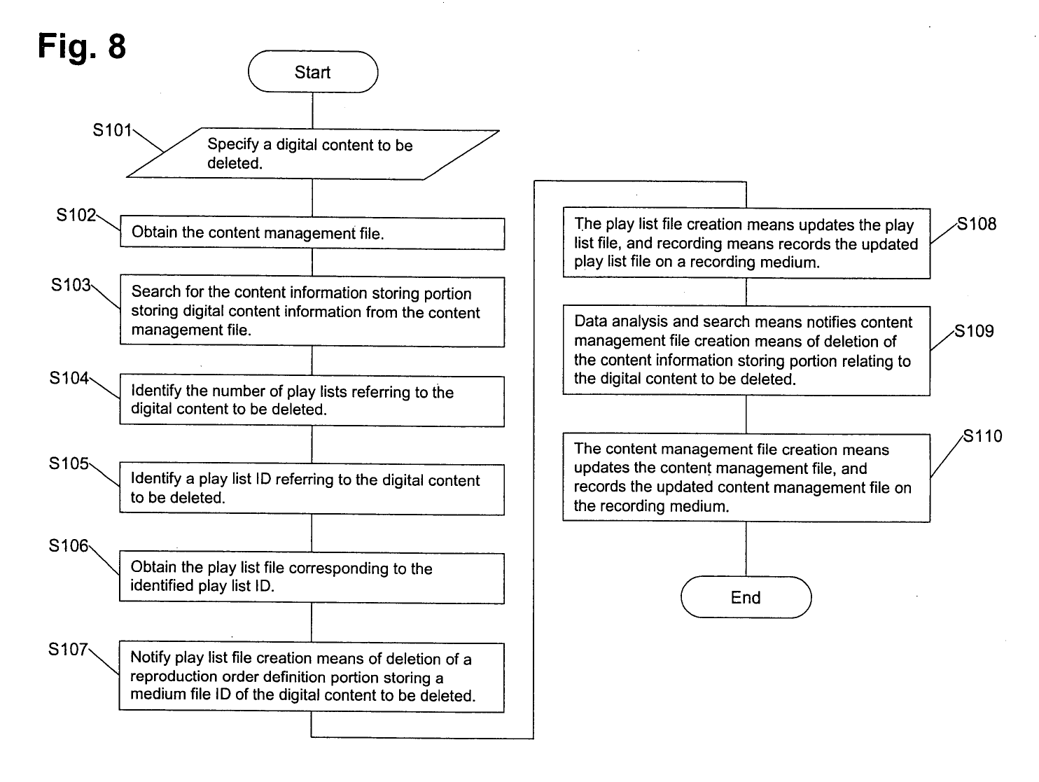

Using a flow chart in FIG. 8, a description will be given as to a flow of a process in which the recording apparatus 100 updates the content management file 130 and the play list file 140 in the case where, by using the recording apparatus 100, the user deletes a certain digital content (hereafter, a digital content 123a) from the recording medium 120 on which the content management file 130, the play list file 140 and the digital content 123 are recorded in a predetermined data structure.

The user specifies the digital content 123a to be deleted from the recording medium 120 by using display selection means (not shown) capable of displaying, referring to and selecting the information of the recording medium 120 recorded in the predetermined data structure (step S101).

Once the digital content 123a to be deleted is specified at step S101, the file information obtaining means 106 reads the content management file 130 (step S102).

The data analysis and search means 107 searches for the information on the relevant digital content 123a from the content management file 130 read by the file information obtaining means 106 at step S102. To be more specific, it compares the file name of the digital content 123a to be deleted to the file name storing portion 135 of the content information storing portion 131 of the digital contents of the content management file 130, and searches the relevant content information storing portion 131 to store the medium file ID. According to the first embodiment, the medium file ID of the relevant digital content 123a is #m (step S103).

Next, the data analysis and search means 107 identifies the number of the play list files referring to the digital content 123a to be deleted from the reference play list file number storing portion 133 of the content information storing portion 131 of the digital content 123a at step S103 (step S104).

Furthermore, based on the number of reference play list files obtained at step S104, the data analysis and search means 107 obtains the play list IDs of the play list files referring to the digital content 123a to be deleted from the reference play list file information storing portion 134 of the content information storing portion 131 of the relevant digital content 123a. According to this embodiment, the number of the play list files referring to the digital content 123a to be deleted is two, and the play list IDs of the play list files are #1 and #k (step S105).

Of the play list IDs of the play list files identified by the data analysis and search means 107 at step S105, the file information obtaining means 106 identifies the file name of the play list file requiring an update due to deletion of the digital content 123a out of the plurality of play list files existing on the recording medium 120 so as to read the relevant play list file (step S106).

The data analysis and search means 107 searches the content reproduction order definition portion 141 from the play list files #1 and #k read from the file information obtaining means 106 at step S106, and notifies the play list file creation means 104 of deletion of the data in which the medium file ID of the relevant digital content 123a to be deleted #m is stored (step S107).

In the case where the digital content referring to a subject play list file is only the digital content 123a, it is also possible to delete the relevant play list file itself and notify the play list file creation means 104 thereof.

When notified of the deletion of the data in which the medium file Ids, #1 and #m of the digital content 123a to be deleted are stored at step S107, the play list file creation means 104 deletes from the play list files (play lists #1 and #k) the information on the medium file ID #m notified of by the data analysis and search means 107 to update the play list files and notifies the recording means that the updated play list files will be recorded on the recording medium 120. The recording means 105 records the updated play list files on the recording medium 120 (step S108).

The data analysis and search means 107 then notifies the content management file creation means 102 of deletion of the content information on the digital content 123a from the content information storing portion 131 of the content management file 130 (step S109).

When notified by the data analysis and search means 107 that the content information on the digital content 123a will be deleted from the content information storing portion of the content management file 130 at step S109, the content management file creation means 102 deletes the data specified by the data analysis and search means 107 to update the content management file 130. The recording means 105 records the updated content management file 130 on the recording medium 120 (step S110).

Thus, in the case where the digital content 123a is deleted from the recording medium 120, in order to update the play list file 140 referring to the digital content 123a, the recording apparatus 100 can identify and update the relevant play list files by using the information stored in the reference play list file information storing portion 134 of the content management file 130, that is, the number of the reference play list files 133 and play list IDs stored in the reference play list file information storing portion 134 without reading all the play list files 140 and searching the content reproduction order definition portion 141. It is thereby possible, in the case where the digital content is deleted, to reduce time required to search for the play list files to be updated out of the plurality of existing play list files.

### Second Embodiment

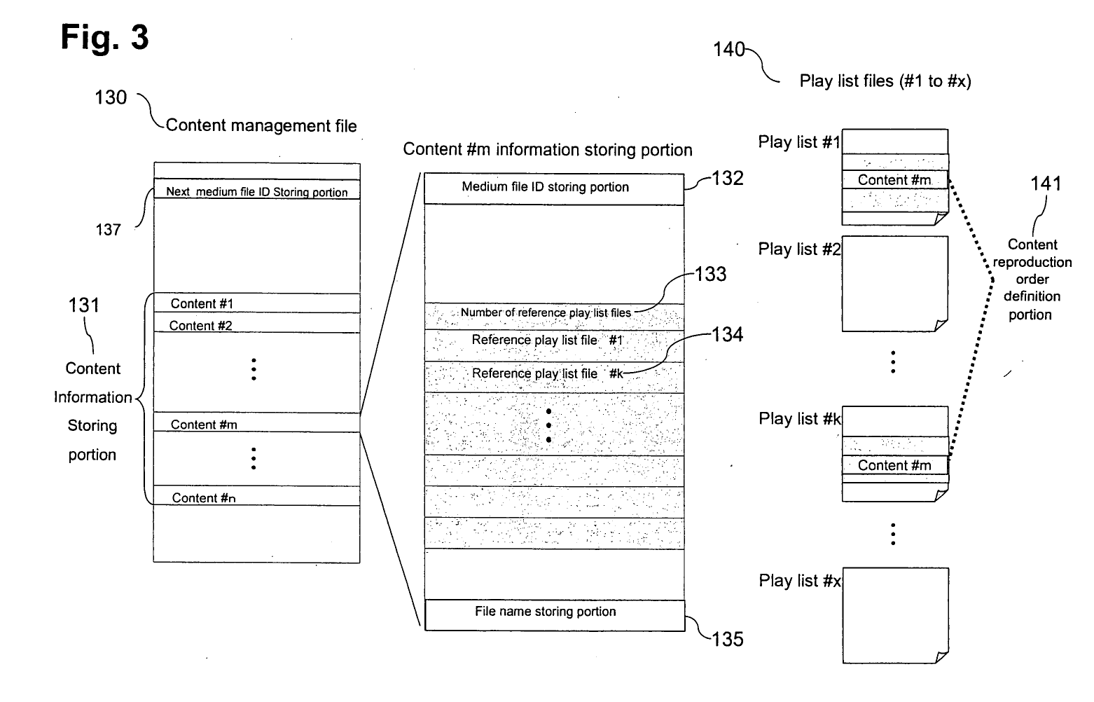

(FIG. 3: Data Structure Diagrams of the Content Management File and the Play List File Comprising a Next Medium File ID Storing Portion on Adding the Digital Contents)

FIG. 3 are data structure diagrams of the content management file 130 and the play list file 140 created by the recording apparatus 100 according to this second embodiment and recorded on the recording medium 120, and shows in particular the data storing portion created and updated (added or deleted) in this embodiment.

The content management file 130 has a next medium file ID storing portion 137 of storing the medium file ID to be provided to the digital content to be added next from the medium file IDs provided to the digital contents.

When creating the recording medium 120 having the content management file 130, the play list file 140 and the digital content 123 recorded in a predetermined data structure thereon, the recording apparatus 100 stores in the next medium file ID storing portion 137 the medium file ID to be provided to the digital content to be added next (for instance, a maximum value of the medium file ID provided to each digital content plus 1) from the medium file Ids provided to the digital contents 123.

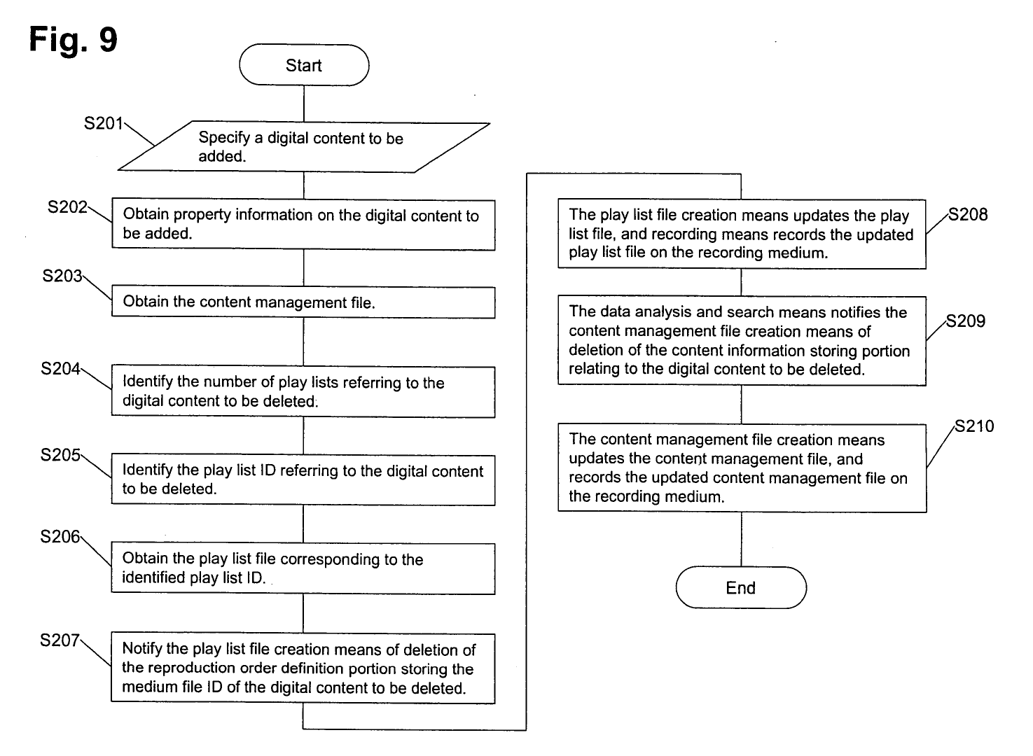

Using a flow chart in FIG. 9, a description will be given as to a flow of a process in which the recording apparatus 100 updates the content management file 130 and the play list file 140 in the case where, by using the recording apparatus 100 shown in FIG. 1, the user adds a certain digital content (hereafter, a digital content 123b) to the recording medium 120 on which the content management file 130, the play list file 140 and the digital contents 123 are recorded in the predetermined data structure.

The user specifies the digital content 123b to be newly added to the recording medium 120 by using the display selection means (not shown) capable of displaying, referring to and selecting the information of the recording medium 120 recorded in the predetermined data structure and further selecting the digital content to be added to the recording medium 120 (step S201).

Once the digital content 123b to be added is specified at step S201, the recording apparatus 100 instructs the information extraction means 101 to obtain the information on the relevant digital content, and the information extraction means 101 obtains the property information on the digital content 123b to be added (step S202).

The recording apparatus 100 then instructs the file information obtaining means 106 to read the content management file 130, and the file information obtaining means 106 reads the content management file 130 (step S203).

The data analysis and search means 107 searches for the content information storing portion 131 from the content management file 130 read from the file information obtaining means 106 at step S203 so as to identify an area of storing the information on the digital content 123b and notify the content management file creation means 102 thereof (step S204).

The data analysis and search means 107 also identifies the medium file ID to be provided to the digital content 123b to be added from the next medium file ID storing portion 137, and notifies the content management file creation means 102 thereof. According to this embodiment, the medium file ID to be provided to the digital content 123b to be added is #n (step S205).

The content management file creation means 102 newly creates the content information storing portion for the digital content 123b and updates the content management file 130 by using the information on the digital content 123b obtained by the file information obtaining means 106 at step S202, the area of writing the content information identified by the data analysis and search means 107 at step S204, and the medium file ID, #n to be provided to the digital content 123b specified by the data analysis and search means 107 at step S205 (step S206).

The content management file creation means 102 also updates the ID to be stored in the next medium file ID storing portion 137 further to the ID to be provided on adding the next digital content. The ID to be provided on adding the next digital content may be any value as long as it is the value uniquely identifiable on the digital content recording medium 120. According to this embodiment, a value (n+1) larger than the ID provided to the digital content 123b by 1 is stored (step S207).

Next, the recording apparatus 100 notifies the file information obtaining means 106 to read one or a plurality of the relevant play list files in order to update the play list files based on the reproduction order of the digital content 123b specified by the content reproduction order specification means 103 at step S201 (step S208).

The file information obtaining means 106 reads one or a plurality of the relevant play list files notified at step S208 (step S209).

The data analysis and search means 107 notifies the play list file creation means 104 that the medium file ID, #n of the digital content 123b of which reproduction order is newly defined is added to the content reproduction order definition portion 141 of each play list file read from the file information obtaining means 106 at step S209 (step S210).

The play list file creation means 104 adds specified data to a specified location of the relevant play list file to update the play list file notified at step S210 (step S211).

The recording means 105 records the play list file updated at step S211 on the recording medium 120 (step S212).

As described above, in the case of newly adding the digital content 123b to the recording medium 120, the recording apparatus 100 does not search all the content information storing portions of the content management file 130 for providable medium file IDs in order to identify the medium file ID to be provided to the digital content 123b. But it obtains the providable medium file IDs from the next medium file ID storing portion 137 of the content management file 130 so as to create the content information storing portion 131. Thus, it is possible to reduce update processing time of the content management file 130 in the case of adding the digital contents.

### Third Embodiment

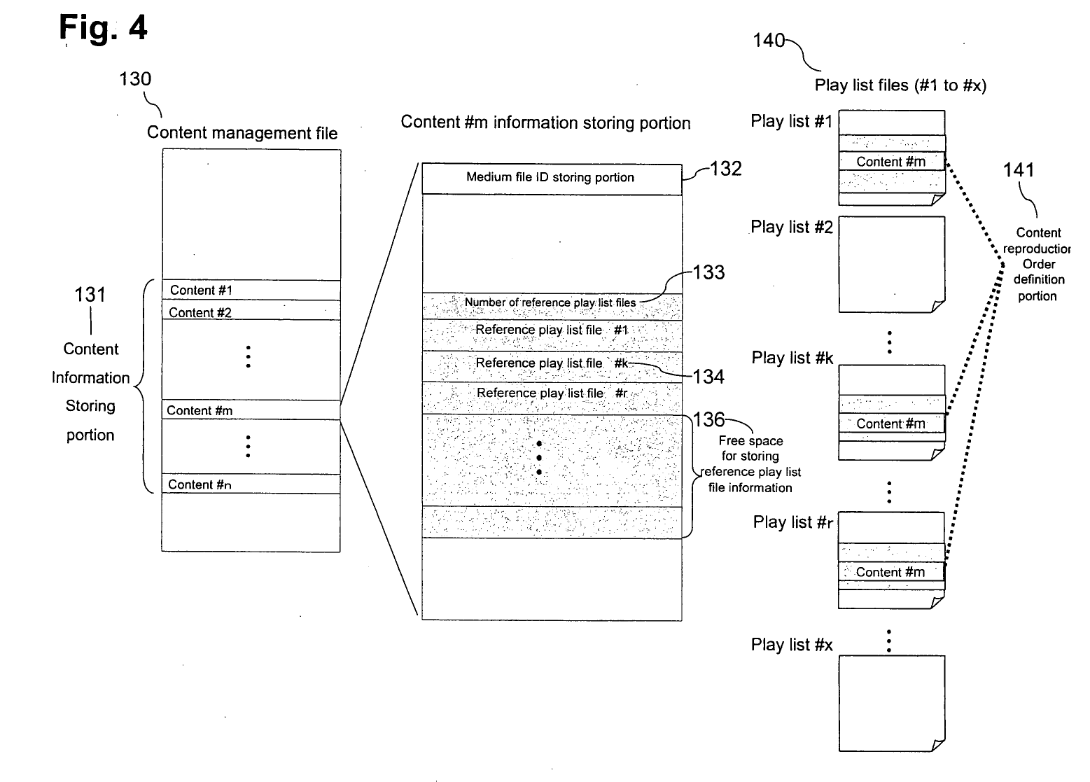

(FIG. 4: Data Structure Diagrams of the Content Management File and the Play List File Comprising Free Space of Storing Reference Play List File Information)

FIG. 4 are data structure diagrams showing data storing portions created and updated in this embodiment in particular out of the data structures of the content management file 130 and the play list file 140 created by the recording apparatus 100 according to a third and a fourth embodiments.

The content information storing portion 131 has a free space of storing reference play list file information 136 in advance in preparation for addition and deletion of the reference play list file information.

The free space of storing reference play list file information 136 is created by adding data free space of a predetermined size at a predetermined position of the content management file 130 in the case where the recording apparatus 100 newly records the digital contents 123, the content management file 130 and the play list file 140 in a predetermined data structure on the recording medium 120. The size of the free space can be specified by the user by user input means (not shown). It may be the size determined based on that size or the size recorded in a recording area (not shown) of recording the size of the free space in advance held by the recording apparatus 100.

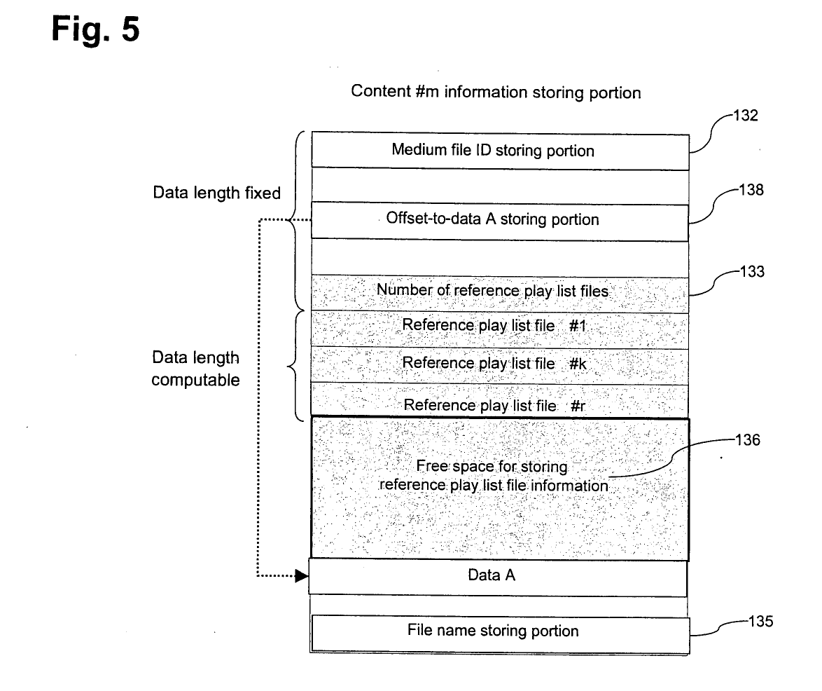

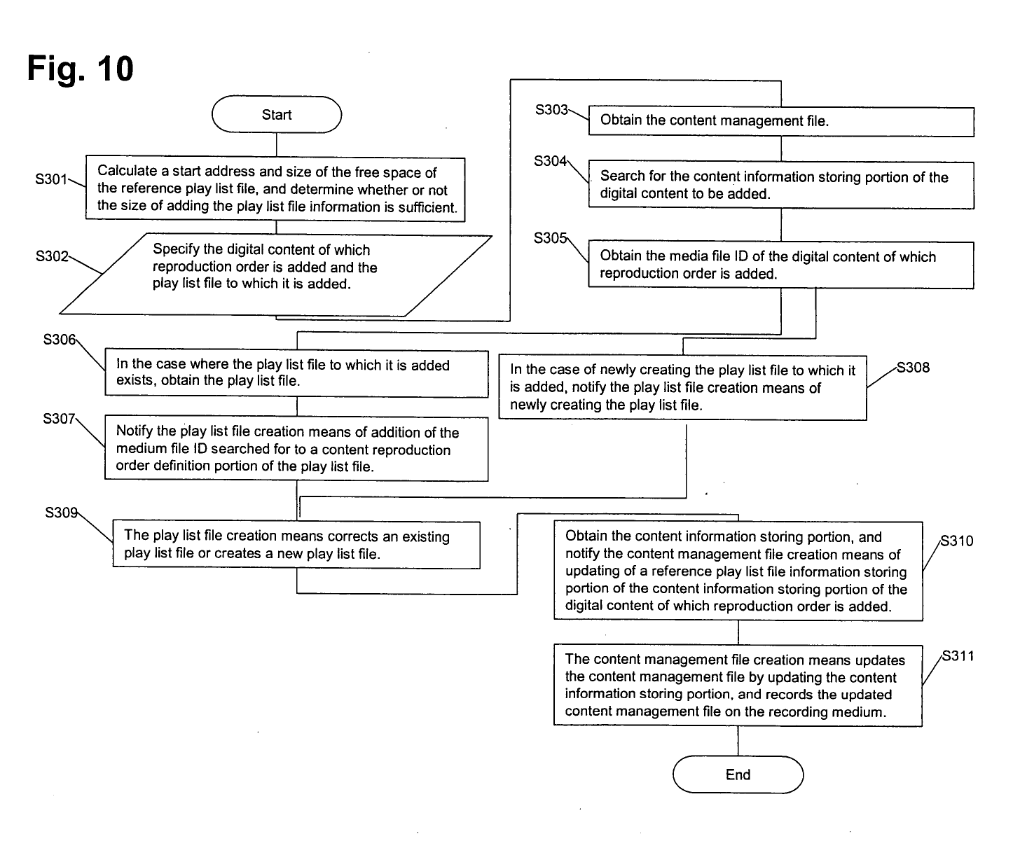

Using a flow chart in FIG. 10 and a data structure diagram in FIG. 5, a description will be given as to the flow of the update process of the content management file 130 and the play list file (play list file 140c) in the case where, by using the recording apparatus 100 shown in FIG. 1, the user adds a definition of the reproduction order of a certain digital content (hereafter, a digital content 123c) to an existing play list file or adding the play list file defining the reproduction order of the digital content 123c on the recording medium 120 on which the content management file 130, the play list file 140 and the digital contents 123 are recorded in the predetermined data structure.

First, in the case of newly adding the play list file information to be referred to to the free space of storing reference play list file information 136, a start address and the size in the content management file 130 of the free space of storing reference play list file information 136 are calculated in order to determine whether or not a data size of storing the play list file information is sufficient.

(FIG. 5: A Data Structure Diagram of the Content Information Storing Portion 131 (the Medium File ID is #m) Showing the Data to be Used when Identifying the Start Address and Size of the Free Space of Storing Reference Play List File Information 136 in the Content Management File 130)

An offset-to-data A storing portion 138 stores the start address of the data A stored immediately following the free space of storing reference play list file information 136.

In the content information storing portion 131 of the content #m, the data from the medium file ID storing portion 132 to the reference play list file number storing portion 133 is fixed-length. One area storing the reference play list information also has fixed-length data. The data size of all the areas storing the reference play list information can be calculated from the number of the reference play list files stored in the reference play list file number storing portion 133 and the data size of the one area storing the reference play list information. Thus, it is possible to identify a starting position of the free space of storing reference play list file information 136.

The size of the free space of storing reference play list file information 136 can be calculated from the start address of the free space of storing reference play list file information 136 calculated earlier and an offset value stored in the offset-to-data A storing portion 138. Thus, in the case of newly adding the play list file information to be referred to to the free space of storing reference play list file information 136, it is possible to determine whether or not the size of storing the information is sufficient (step S301).

The user specifies the digital content 123c of which the definition of the reproduction order is newly added from the recording medium 120 to the play list file and the play list file 140c to which it is added by using the display selection means (not shown) capable of displaying, referring to and selecting the information of the recording medium 120 recorded in the predetermined data structure. According to this embodiment, the medium file ID of the digital content 123c of which the definition of the reproduction order is added to the play list file 140c is #h (step S302).

If the digital content of which definition of the reproduction order is newly added to the play list file and the play list file to which it is added are specified at step S302, the file information obtaining means 106 reads the Content management file 130 from the recording medium 120 (step S303).

The data analysis and search means 107 searches for the content information storing portion of the digital content 123c of which definition of the reproduction order is to be added to the play list file 140c from the content information storing portion 131 of the content management file 130 read from the file information obtaining means 106 at step S303. To be more specific, it compares the file name of the digital content 123c to the file name stored in the file name storing portion 135 of the content information storing portion 131 so as to detect the content information storing portion 131 of a matching file name (step S304).

Furthermore, the data analysis and search means 107 searches the medium file ID storing portion 132 of the content information storing portion 131 detected at step S304, and detects and stores the medium file ID of the digital content 123c of which the definition of the reproduction order is added to the play list file 140c, that is, the content #h (step S305) The file information obtaining means 106 identifies the play list file 140c from the play list IDs of the play list file 140c selected by the display selection means at step S302, and reads the relevant play list file 140c (step S306).

The data analysis and search means 107 searches the content reproduction order definition portion 141 of the play list file 140c read from the file information obtaining means 106 at step S306, and notifies the play list file creation means 104 to additionally store the medium file ID #h of the digital content 123c detected from the content management file 130 in reproduction order (step S307).

In the case of adding to the recording medium 120 a new play list file defining the reproduction order of one or a plurality of digital contents including the digital content 123c at step S302, the data analysis and search means 107 newly creates the play list file and notifies the play list file creation means 104 that the medium file ID #h of the digital content 123c defining the reproduction order is added to the content reproduction order definition portion 141 of the created play list file (step S308).

The play list file creation means 104 additionally corrects the play list file specified at step S307 or newly creates the play list file specified at step S308 (step S309).

The file information obtaining means 106 reads the content management file 130. The data analysis and search means 107 searches for the content information storing portion 131 relating to the content #h, by using the medium file ID, from the content information storing portions 131 of the content management file 130 read from the file information obtaining means 106. And it increases the number of reference play list files of the reference play list file number storing portion 133 and notifies the content management file creation means 102 to add the IDs of the play list files to which reference to the content #h is added to the free space of storing reference play list file information 136 (step S310).

The content management file creation means 102 adds the specified information at a location specified at step S310 and updates the content management file 130 so as to record the updated content management file 130 on the recording medium 120 (step S311).

As described above, in the case of adding a new reproduction order of the digital content to the content reproduction order definition portion 141 of the existing play list file 140, or in the case of newly creating the play list file 140 defining the reproduction order of one or a plurality of digital contents, it is possible for the recording apparatus 100, if the size of the free space of storing the play list file information is sufficient, to add the reference play list file information to the free space of storing reference play list file information 136 of the content management file 130 and correctly update the content management file 130 without rewriting any data beyond the area where the data of the content information storing portions 131 was added. Therefore, it is possible to reduce rewrite processing time of the content management file.

### Fourth Embodiment

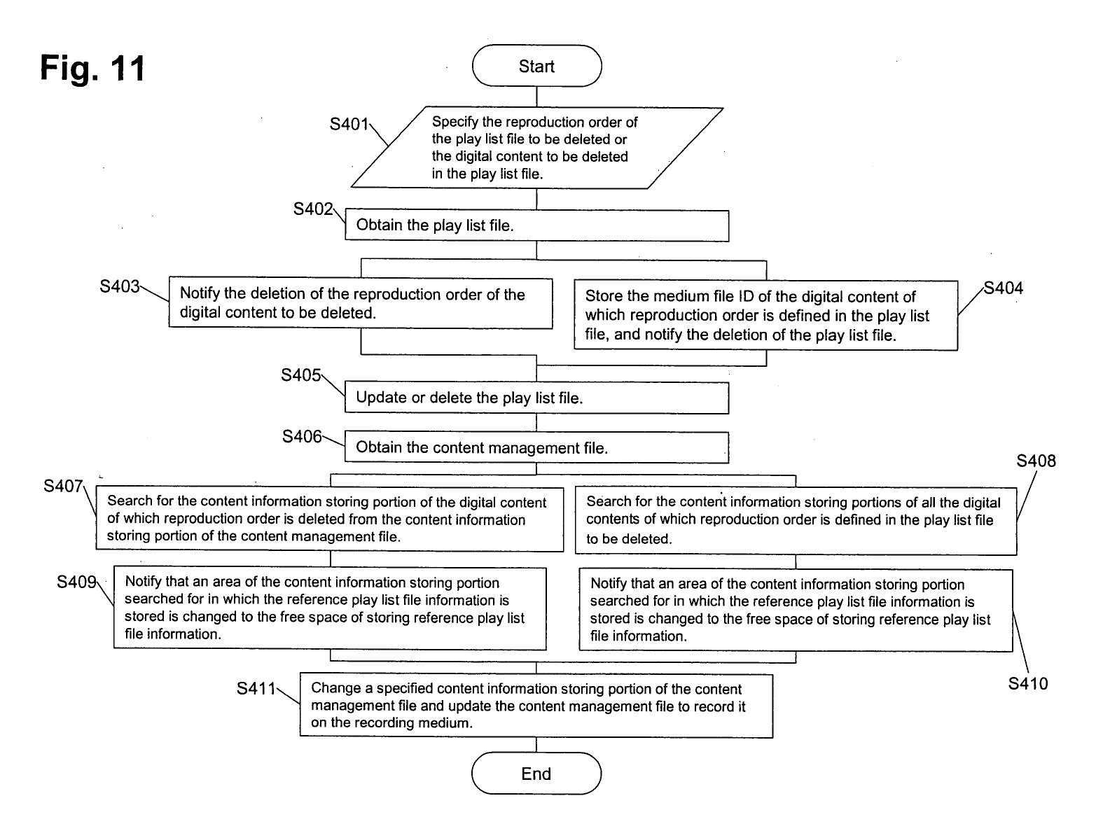

Next, using a flow chart in FIG. 11, a description will be given as to the flow of the update process of the content management file 130 and the play list file 140b in the case where, by using the recording apparatus 100 shown in FIG. 1, the user deletes the definition of the reproduction order of a certain digital content (hereafter, a digital content 123d) from the existing play list file or deletes the play list file defining the reproduction order of the digital content 123 on the recording medium 120 on which the content management file 130, the play list file 140 and the digital contents 123 are recorded in the predetermined data structure.

The user specifies a certain play list file (a play list file 140d) from the recording medium 120 and further specifies the digital content 123d of which the definition of the reproduction order is deleted from the play list file 140d by using the display selection means (not shown) capable of displaying, referring to and selecting the information of the recording medium 120 recorded in the predetermined data structure. According to this embodiment, the play list ID of the play list file 140d of which the reproduction order is deleted is #p, and the medium file ID of the digital content 123d of which the definition of the reproduction order is deleted from the play list file 140d is #j (step S401).

The file information obtaining means 106 identifies the play list file from the play list ID of the play list file selected by the display selection means at step S401, and reads the relevant play list file 140d (step S402).

The data analysis and search means 107 searches the content reproduction order definition portion 141 of the play list file 140d read from the file information obtaining means 106 at step S402, and notifies the play list file creation means 104 to delete the medium file ID, #j selected by the display selection means from the reproduction order (step S403).

In the case of deleting the specified play list file, the data analysis and search means 107 stores the medium file ID stored in the content reproduction order definition portion 141 of the play list file read from the file information obtaining means 106 at step S402. And it notifies the play list file creation means 104 to delete the relevant play list file (step S404).

The play list file creation means 104 additionally modifies or deletes the specified play list file at step S403 or step S404 (step S405).

Once the play list file is additionally corrected or deleted at step S405, the file information obtaining means 106 then reads the content management file 130 from the recording medium 120 (step S406).

The data analysis and search means 107 searches the content information storing portion of the digital content 123d of which the definition of the reproduction order is deleted from the play list file 140d from the content information storing portions 131 of the content management file 130 read from the file information obtaining means 106 at step S406. To be more specific, it compares the medium file ID #j of the digital content 123d to the medium file ID stored in the medium file ID storing portion 132 of the content information storing portion 131 so as to detect the content information storing portion 131 of a matching medium file ID (step S407).

In the case of deleting the existing list file on the recording medium 120, the data analysis and search means 107 detects the content information storing portion 131 of the medium file defined in the content reproduction order definition portion 141 of the play list file from the content information storing portion 131 of the content management file 130 read from the file information obtaining means 106 at step S406 (step S408).

Once the data analysis and search means 107 searches the content information storing portion 131 relating to the content #j, by using the medium file ID, from the content information storing portions 131 of the content management file 130 read from the file information obtaining means 106 at step S407, it notifies the content management file creation means 102 to decrease the number of the reference play list files of the reference play list file number storing portion 133, delete the play list ID #p of the play list file 140d referring to the digital content 123d from the area storing the reference play list file information and change it to the free space of storing reference play list file information 136 (step S409).

In the case of deleting the existing play list file on the recording medium 120, once the data analysis and search means 107 detects the content information storing portion 131 based on the stored medium file ID at step S408, it decreases the number of the reference play list files and notifies the content management file creation means 102 to delete the play list ID of the play list file to be deleted from the reference play list file information storing portion 133 and change it to the free space of storing play list file information 136 (step S410).

The content management file creation means 102 deletes and modifies the specified information at the location specified at step S409 or S410 and updates the content management file 130 so as to record the updated content management file 130 on the recording medium 120 (step S411).

As described above, in the case of deleting the reproduction order of the digital contents from the content reproduction order definition portion 141 of the existing play list file 140, or in the case of deleting the play list file 140 defining the reproduction order of one or a plurality of digital contents, it is possible for the recording apparatus 100 to delete the reference play list file information from the reference play list file information storing portion 133 and change it to the free space of storing reference play list file information 136 so as to correctly update the content management file 130 without rewriting any data beyond the area where the data was deleted. Therefore, it is possible to reduce rewrite processing time of the content management file.

### Fifth Embodiment

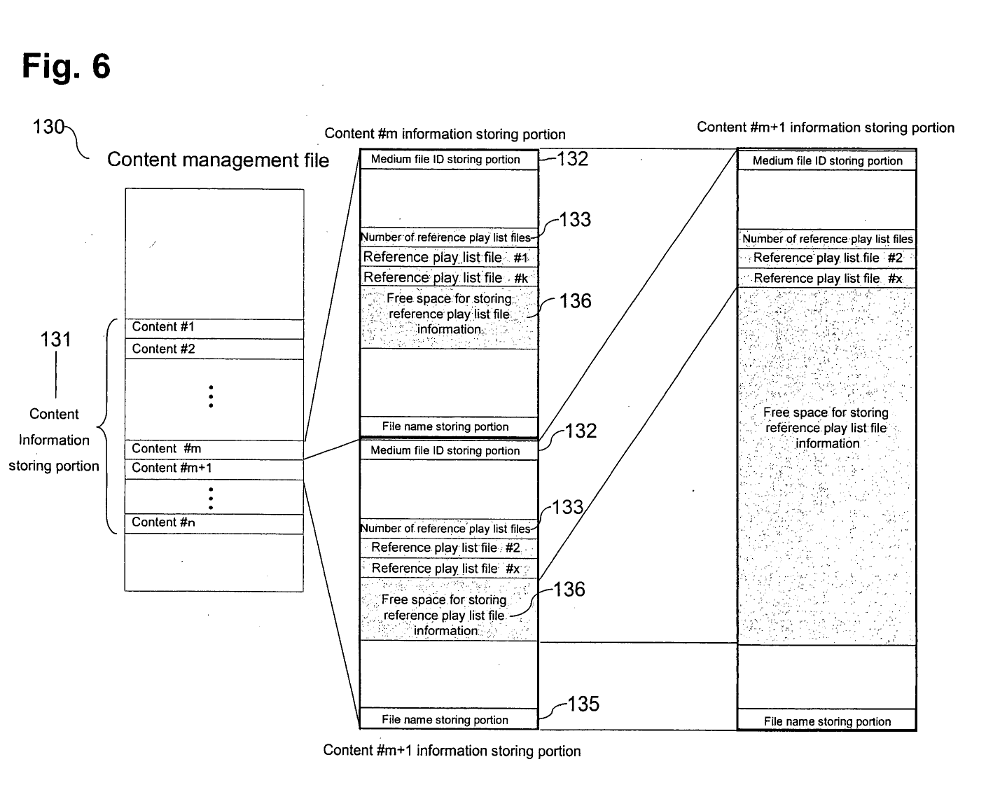

(FIG. 6: A Data Structure Diagram of Two Successive Content Information Storing Portions (the Medium File IDs are #m and #m+1) Having the Free Space of Storing Reference Play List File Information in the Content Management File)

FIG. 6 is a data structure diagram showing the data storing portions to be updated in this embodiment in particular out of the data structure of the content management file 130 created by the recording apparatus 100 according to the fifth embodiment.

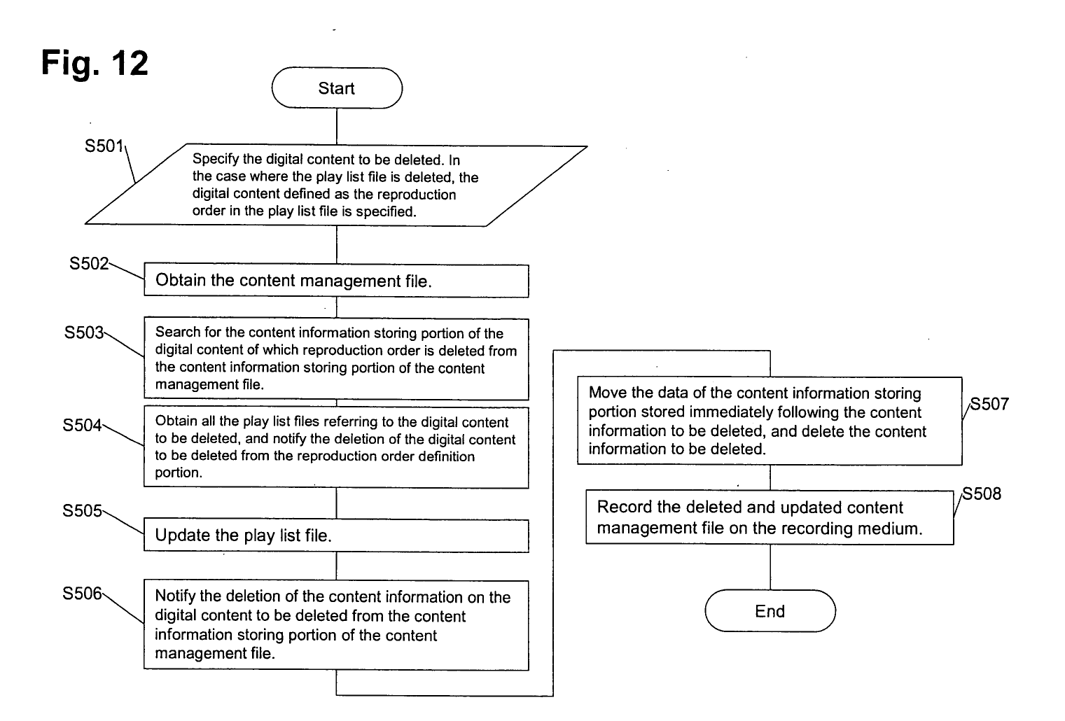

A description will be given by using a flowchart in FIG. 12 as to a flow of an update process of the content management file 130 in the cases of using the recording apparatus 100 shown in FIG. 1, where the content management file 130, holding the free space of storing reference play list file information 136 for the sake of adding and deleting the reference play list file information, deletes a certain digital content (referred to as a content 123e) from the recording medium 120 recorded in a predetermined data structure, or deletes the reproduction order of the digital content 123e from an existing play list file and consequently the play list file defining the digital content 123e in the reproduction order no longer exists, or deletes the play list file defining the reproduction order of the digital content 123e and consequently the play list file defining the digital content 123e or another digital content (referred to as 123f) referred to by the deleted play list file in the reproduction order no longer exists.

The user specifies the digital content 123e to be deleted from the recording medium 120 by using display selection means (not shown) capable of displaying, referring to and selecting the information of the recording medium 120 recorded in the predetermined data structure. The medium file ID of the selected digital content 123e to be deleted is #m according to this embodiment.

In the case of deleting the play list file defining the reproduction order of the digital content 123e and consequently deleting the digital content 123e or another digital content 123f referred to by the deleted play list file, the medium file ID of the digital content 123f is #m (step S501).

Once the digital content to be deleted is specified at step S501, the file information obtaining means 106 reads the content management file 130 from the recording medium 120 (step S502).

The data analysis and search means 107 searches for the content information storing portion storing the information on the digital content 123e selected by the display selection means from the content information storing portion 131 of the content management file 130 read from the file information obtaining means 106 at step S502. To be more specific, it compares the file name of the digital content 123e selected by the display selection means to the information on the digital contents stored in the content information storing portion 131 so as to detect the content information storing portion 131 matching with the file name (step S503).

The data analysis and search means 107 identifies the play list file referring to the digital content 123e from the area storing the reference play list file information on the digital content 123e. And it notifies the play list file creation means 104 of deletion of the digital content 123e out of the play list file (step S504).

The play list file creation means 104 corrects the specified play list file (step S505).

Furthermore, the data analysis and search means 107 notifies the content management file creation means 102 of the deletion of the content information storing portion of the digital content 123e from the content information storing portion 131 of the content management file 130 (step S506).

If notified of the medium file ID of the digital content to be deleted from the data analysis and search means 107, the content management file creation means 102 copies the data from the top (medium file ID storing portion 132) of the content information storing portion (the medium file ID of the stored digital content is #m+1) stored immediately following the content information to the top of the free space of storing reference play list file information 136 in the content information storing portion 131 to a top area of the content information storing portion of which medium file ID is #m. And it deletes all the data from a backmost portion of the copied data to the free space of storing reference play list file information 136 of which medium file ID is #m+1 by rendering it all zero (step S507).

The recording means 105 records the updated content management file 130 on the recording medium 120 (step S508).

As described above, in the case of deleting a certain digital content from the recording medium 120, the recording apparatus 100 detects the information on the digital content from the content information storing portion 131 of the content management file 130. Of the information on the digital content stored immediately following the detected information, the recording apparatus 100 copies the data more forward than a free space of storing reference play list file information 136b to the top area of the information storing portion of the digital content to be deleted. And it deletes the data from a copy ending position to the free space of storing reference play list file information 136 of a next content information storing portion by rendering it all zero, and increases the size of the free space of storing reference play list file information 136 of the digital content stored immediately following the digital content to be deleted. Thus, it is possible to correctly update the content management file 130 without rewriting the content information stored in the content information storing portion of the deleted digital content and thereafter.

According to this embodiment, the content management file 130 stores the medium file ID provided to the digital contents 123 and the play list file 140 defines the reproduction order of the contents by using the provided medium file ID. However, the play list file 140 may also store the file names of the digital contents as the definition of the reproduction order of the digital contents.

According to this embodiment, the content information storing portions 131 of the content management file 130 is detected by using the medium file ID provided to the digital contents 123 in the case of deleting the definition of the reproduction order of the digital contents 123 from the play list file 140. However, it may also be detected by using the file name of the digital contents 123.

According to this embodiment, the file name of the play list file 140 is created from the character string including the play list ID provided to the play list file 140 or the play list ID itself, and the play list ID is stored in the reference play list information storing portion 134 of the content information storing portions 131 of the content management file 130. However, the play list file may have an arbitrary file name, and the file name of the relevant play list file may be stored in the reference play list information storing portion 134 of the content information storing portions 131 of the content management file 130.

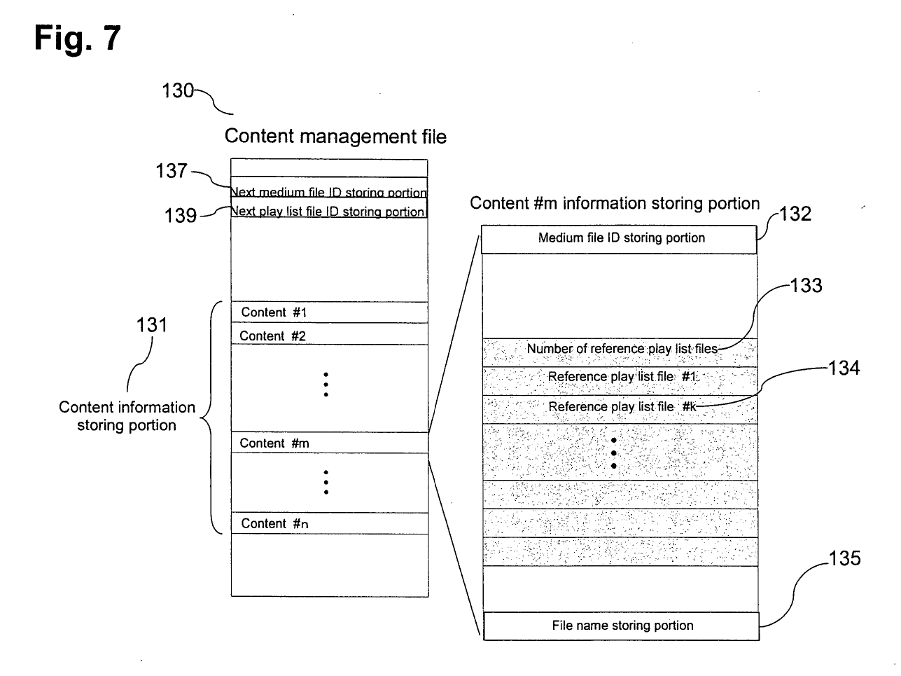

In the case of using the play list ID for management of the play list file 140, it is also possible, in consideration of the case of having the play list file newly added, to have a next play list file ID storing portion 139 held by the content management file 130 as shown in FIG. 7 which is a data structure diagram of the content management file according to the fifth embodiment. When using the play list ID stored in the next play list file ID storing portion 139, it is not necessary, in the case of creating a new play list file, to search the entire existing play list IDs and specify an unused ID. And it is possible to provide the ID to the play list file to be created by referring to the next play list file ID storing portion 139.

According to this embodiment, the content information on the digital content 123e and the content information on the digital content 123f are deleted from the content information storing portion 131 of the content management file 130 in the case where the definition of the reproduction order of the digital content 123e is deleted from the existing play list file and there consequently exists no play list file defining the digital content 123e in the reproduction order or in the case where the play list file defining the reproduction order of the digital content 123e is deleted and there consequently exists no play list file defining the digital content 123e or another digital content (digital content 123f) in the reproduction order. It is also possible, however, to delete only the information on the deleted play list file from the area storing the reference play list information without deleting the content information.

The recording apparatus 100 also has a storage area (not shown) of memorizing that no addition of the reproduction order of the contents should be made to the play list file 140 and a certain digital content. It can also create the content management file 130 without securing the free space of storing reference play list file information 136 in the case of newly recording the digital contents 110, the content management file 130 and the play list file 140 on the recording medium 120 and making no addition of the reproduction order of the contents to the play list file 140 and the certain digital content. Thus, it is possible to leave out a preliminary storage area to add the data and reduce the size of the content management file 130 so as to alleviate a data reading process of a reproducing apparatus and so on and improve processing speed.

The recording apparatus 100 can also add an area of a predetermined size to all or part of the content information storing portions 131 in the case where there is little area remaining in the free space of storing reference play list information while sequentially adding the reference play list file information to the content management file 130 having the free space of storing reference play list file information 136.

1. A recording system comprising:
a recording medium holding (a) a plurality of contents, (b) a plurality of play list files indicating reproduction order of all or a part of the plurality of contents and (c) a content management file of storing content management information indicating which of the contents are listed in which of the play list files;
obtaining means of obtaining the content management information stored in the content management file; and
play list file operation means of, in the case where the contents to be deleted from the recording medium are specified in the plurality of contents held by the recording medium, using the obtained content management information to either delete or update the play list file listing the contents to be deleted out of the plurality of play list files.

2. The recording system according to claim 1, wherein, in the case where the contents to be added to the recording medium are specified and the play list file to be used to list the contents to be added is also specified in the plurality of play list files, the play list file operation means updates the play list file to be used to list the contents to be added.

3. The recording system according to claim 1, wherein, in the case where the contents to be added to the recording medium are specified and the play list file listing the contents to be added is added, the play list file operation means adds the play list file listing the contents to be added.

4. The recording system according to any one of claims 1 to 3, further comprising content management file updating means of updating the content management file in response to any of the deletion, update and addition of the play list file.

5. The recording system according to claim 4, wherein the content management file has an area of a predetermined size secured in advance in order to store the content management information.

6. The recording system according to claim 4, wherein:
the plurality of contents held by the recording medium are provided with unique IDs used to describe the content management information respectively; and
the content management file has a next ID storage portion storing in advance the ID to be given to the content to be added to the recording medium next.

7. A recording apparatus comprising:
obtaining means of obtaining content management information stored in a content management file held by a recording medium holding (a) a plurality of contents, (b) a plurality of play list files indicating reproduction order of all or a part of the plurality of contents and (c) the content management file of storing the content management information indicating which of the contents are listed in which of the play list files; and
play list file operation means of, in the case where the contents to be deleted from the recording medium are specified in the plurality of contents held by the recording medium, using the obtained content management information to either delete or update the play list file listing the contents to be deleted out of the plurality of play list files.

8. A recording medium holding (a) a plurality of contents, (b) a plurality of play list files indicating reproduction order of all or a part of the plurality of contents and (c) a content management file of storing content management information indicating which of the contents are listed in which of the play list files, wherein:
the content management information stored in the content management file is obtained; and
in the case where the contents to be deleted from the recording medium are specified in the plurality of contents held by the recording medium, the obtained content management information is used to either delete or update the play list file listing the contents to be deleted out of the plurality of play list files.

9. A recording method comprising:
an obtaining step of obtaining content management information stored in a content management file held by a recording medium holding (a) a plurality of contents, (b) a plurality of play list files indicating reproduction order of all or a part of the plurality of contents and (c) the content management file of storing the content management information indicating which of the contents are listed in which of the play list files; and
a play list file operation step of, in the case where the contents to be deleted from the recording medium are specified in the plurality of contents held by the recording medium, using the obtained content management information to either delete or update the play list file listing the contents to be deleted out of the plurality of play list files.

10. A program of causing a computer to execute as to the recording method according to claim 9:
an obtaining step of obtaining the content management information stored in the content management file held by the recording medium holding (a) a plurality of contents, (b) a plurality of play list files indicating reproduction order of all or apart of the plurality of contents and (c) the content management file of storing the content management information indicating which of the contents are listed in which of the play list files; and
a play list file operation step of, in the case where the contents to be deleted from the recording medium are specified in the plurality of contents held by the recording medium, using the obtained content management information to either delete or update the play list file listing the contents to be deleted out of the plurality of play list files.

11. A recording medium supporting the program according to claim 10, which is processable by the computer.

12. A recording system comprising:
a recording medium holding (a) a plurality of contents, and (b) a plurality of play list files indicating reproduction order of all or a part of the plurality of contents; and
content management file recording means of recording content management information indicating which of the contents are listed in which of the play list files in a content management file of storing the content management information held by the recording medium.
